(19) United States
(12) Patent Application Publication
(10) Pub. No.: US 2025/0207861 A1
(43) Pub. Date: Jun. 26, 2025

(54) APPARATUS FOR INSPECTING AND/OR RESTORING A HOSTILE ENVIRONMENT AND CORRESPONDING METHOD

(71) Applicants: DANIELI & C. OFFICINE MECCANICHE S.P.A., BUTTRIO (UD) (IT); DANIELI AUTOMATION S.P.A, BUTTRIO (UD) (IT)

(72) Inventors: Andrea DE LUCA, REMANZACCO (UD) (IT); Maurizio PASSONI, REANA DEL ROJALE (UD) (IT); Luca GHIO, GENOVA (IT); Marco MORANDO, GENOVA (IT)

(21) Appl. No.: 18/847,325

(22) PCT Filed: Mar. 17, 2023
(86) PCT No.: PCT/IT2023/050081

§ 371 Date: Sep. 16, 2024

(30) Foreign Application Priority Data
Mar. 17, 2022 (IT) 102022000005273

(51) Int. Cl. F27D 21/00; F27D 19/00; F27D 21/02

(52) U.S. Cl. CPC F27D 21/0014; F27D 19/00; F27D 21/02

(57) ABSTRACT

A method for inspecting and restoring a hostile and/or dangerous environment performed by an apparatus includes determining whether to start the inspection of the hostile environment by at least one temperature detection device; performing the inspection by acquiring optical and/or thermal and/or geometric data of at least one zone of the frameable environment by at least one optical and/or thermal and/or geometric data detection device; performing the restoration of the hostile environment by the at least one restoration operator device by positioning, by the positioning support, the tool head inside said environment through the inlet channel.

### FIELD OF THE INVENTION

Embodiments described here concern an apparatus and method for inspecting and/or restoring hostile and/or dangerous environments, in particular for high temperature environments.

The inspection and/or restoration method is used to carry out an inspection, which can also include taking a sample, of a hostile and/or dangerous environment where an operator cannot have direct access in safe conditions, and to perform restoration and maintenance operations in said environment, wherein the restoration operation can take place before or after the inspection operation, or even independently thereof.

Preferentially, but not restrictively, the inspection and/or restoration method can be applied in the iron and steel sector for the production of steel or other metals, or in the production of glass materials, in which there are, for example, electric furnaces, ladles, submerged arc furnaces, melting or refining furnaces, induction melting furnaces or induction reheating furnaces or suchlike.

### BACKGROUND OF THE INVENTION

Hostile environments are known, in which the direct presence of man is not allowed and not possible. Some examples are environments with conditions of extreme temperature, such as extremely high or cryogenic temperatures, but also environments with a high concentration of corrosive gases, or with a potentially explosive atmosphere, or simply unknown environments that are difficult to access.

Examples of these environments may be furnaces for working metal, glass or plastic materials, freezing apparatuses, nuclear plants, plants for the production of aggressive chemical substances and suchlike.

Often, or periodically, it is necessary to inspect these environments, for example to assess the need for maintenance interventions, the status of a production process, the need to secure the environment before an operator accesses it, and so on. A further example may be the need to assess the presence of people in duress, as in the case where the hostile environment is a site where a fire is in progress and the need to intervene to save lives must be assessed.

In addition to the need to inspect a hostile environment, it is sometimes necessary to take a sample of the material being worked, to verify the correctness or evolution of the process, or it is necessary to identify whether it is appropriate to restore some parts of the environment itself. For example, in a metalworking furnace it is useful to identify, between one casting and the next, if it is necessary to restore the refractory material of the furnace in order to prevent damage to the furnace itself, malfunctions and/or inadequate quality of the final product.

Apparatuses are known for acquiring images or videos, for example by means of video cameras, thermal imaging cameras, X-ray systems or lasers, for example installed on a tool head which can be moved by means of suitable drive and control systems. Usually, known devices allow to frame more than one part of the environment, if not a complete 360-degree panoramic view.

Apparatuses are also known for carrying out the restoration by gunning of refractory material in furnaces or metallurgical apparatuses. For example, document WO 03/081157 A1 describes a method for measuring the residual thickness of the coating of a metallurgical container and for restoring the zones of wear thus determined, and a corresponding device to implement this method.

One disadvantage of the devices known in the state of the art is that the operations performed by the individual inspection, sampling and restoration apparatuses require long times, the movement of dedicated equipment, using operators to equip and dispose the different equipment, waiting down times, and yet other disadvantages.

Furthermore, in existing inspection apparatuses, in order to obtain an extended or panoramic view of the environment, it is necessary to install on said head a plurality of image detection devices of the same type, each oriented with respect to the others by a suitable angle, to acquire a multiplicity of images obtained from each of said devices, and subsequently to process them in order to obtain a complete image.

Similarly, existing restoration apparatuses do not allow to perform a diagnosis of the damage suffered by the environments in which operations are being performed and, as for the inspection apparatuses, it is necessary to install a plurality of tools in order to be able to complete the operation to restore the environments.

One disadvantage of the state of the art is that it is necessary to use a plurality of apparatuses in order to be able to inspect and restore a work environment.

Another disadvantage is that it is necessary to perform a plurality of operations and install a plurality of tools in order to be able to perform the inspection operations, to diagnosis the damage, and to restore the initial conditions of the environments.

This affects work times, which are considerably longer, and therefore the efficiency and productivity of any activity that involves the inspection of the work environment and the possible restoration of the initial conditions.

However, because of the criticality due to the environmental conditions, the devices installed on said apparatuses are very onerous from a technological and also an economic point of view. For example, they must be able to withstand extreme temperatures and/or corrosion by any chemical agents.

There is therefore a need to perfect an inspection and restoration apparatus which can overcome at least one of the disadvantages of the state of the art.

In particular, one purpose of the present invention is to provide an inspection, sampling, restoration and maintenance apparatus which can be used in hostile and/or dangerous environments in conditions of substantial safety with respect to damage and malfunctions.

Another purpose of the present invention is to provide an inspection method which allows to perform continuous scans of the environment, to diagnose any possible damage to the environment and to perform operations to restore the environment itself.

Another purpose is to reduce the economic burden required for the image detection and restoration devices or, given the same economic burden, to increase the technological performance of such apparatuses.

Another purpose is to provide a method which can speed up the inspection operations, also comprising the taking of a sample, of a hostile and/or dangerous environment.

Another purpose is to provide a method which can speed up the restoration and maintenance operations in a hostile and/or dangerous environment.

It is also a purpose of the present invention to perfect an apparatus which allows to pursue said purposes.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, some embodiments described here concern a method for inspecting and/or restoring a hostile and/or dangerous environment performed by an apparatus that comprises a tool head and a positioning support. In the apparatus, the tool head is configured to receive at least one operator device, this being at least one of either a temperature detection device, a sampling device for taking one or more samples, an optical and/or thermal and/or geometric data detection device, or a device for restoring at least part of the operating environment.

In accordance with the above purposes, if the hostile environment is a melting furnace, the temperature detection device operates to detect the temperature of the metal bath.

The positioning support is able to be mechanically connected to the tool head and is configured to position the tool head inside the hostile and/or dangerous environment.

The method provides the steps of determining whether to start the inspection of the hostile environment by means of the at least one temperature detection device installed on the tool head, possibly upstream or downstream of a sampling of molten material or slag in order to determine the evolution and correctness of the melting sequence if the environment is a melting furnace; if it has been determined to start the inspection, the method provides to proceed with installing the at least one optical and/or thermal and/or geometric data detection device on the tool head for the inspection of the environment, and to then perform the inspection by positioning, by means of the positioning support, the tool head inside the environment through an inlet channel and acquiring optical and/or thermal and/or geometric data, by means of the at least one optical and/or thermal and/or geometric data detection device, of at least one zone of the environment which can be framed by the at least one image detection device. The method also provides to uninstall the at least one image detection device by positioning, by means of the positioning support, the tool head outside the environment through the inlet channel, to determine whether to perform the restoration of the environment on the basis of a processing of the acquired images, by means of a processing unit comprised in the apparatus and, if it has been determined to perform the restoration, to install at least one restoration device for the restoration of the hostile environment. Finally, the method provides to perform the restoration of the hostile environment by means of the at least one restoration device by positioning, by means of the positioning support, the tool head inside the environment through the inlet channel.

One advantage of this method is that the inspection and restoration of a hostile environment are performed automatically by a same apparatus, therefore without affecting the personal safety of operators.

Another advantage is that the operations of the method are performed automatically by the apparatus, allowing for a considerable saving of labor time, as well as a repositioning of distinct pieces of equipment.

In another example of the invention, the step of the method relating to determining whether to start the inspection comprises installing at least one temperature detection device on the tool head; measuring the temperature of the environment, by means of the at least one temperature detection device, by positioning, by means of the positioning support, the tool head inside the environment through the inlet channel; determining, by means of the processing unit, to start the inspection if the measured temperature is lower than a threshold temperature and uninstalling the at least one temperature detection device by positioning, by means of the positioning support, the tool head outside the environment through the inlet channel.

Advantageously, when the hostile environment is a melting furnace, the method allows to start the inspection when the temperature of the bath corresponds to a target temperature which allows to proceed with the tapping. The inspection and restoration can in fact preferably be performed downstream of the tapping, when the level of steel and slag are minimal, and the walls therefore become more visible.

Moreover, it may be advisable to take one or more samples of steel or slag in order to understand if the melting process is finished and if the chemical target has been reached, in order to then proceed with the tapping and inspection.

In another example of the invention, the method provides to acquire optical and/or thermal and/or geometric data obtained by inserting into the furnace body, preferably downstream of the tapping, a device for detecting images around the axis.

In still another example of the invention, the method comprises evaluating whether the restoration is necessary based on a recognition of the acquired images.

Advantageously, the image detection devices can therefore scan the surrounding environment of the inside of the furnace, which allows to determine the state of wear through the geometric variation undergone by the surfaces over time. In particular, it is also possible to perform continuous scans of the surrounding environment in order to cover a portion, most or all of the internal surface of the furnace.

In another example of the invention, the method comprises, prior to performing the restoration of the environment: installing at least one cleaning operator device to clean the inlet channel by means of the at least one cleaning operator device; and uninstalling the at least one cleaning operator device from the tool head.

In another example of the invention, the method comprises performing the restoration by means of the at least one restoration operator device, this being a gunning lance, spraying refractory material toward the inside of the hostile environment through a rotation of the restoration operator device around a substantially horizontal axis.

In another example of the invention, the method comprises cooling at least one of the at least one operator devices installed on the tool head by means of a flow of gas and/or liquid.

In another example of the invention, the method comprises moving the tool head on the basis of a measurement of an angular position of the tool head obtained by means of a sensor for measuring the angular position which is comprised in the tool head, or, alternatively, on the basis of a pre-set path by means of operator device training.

Furthermore, another aspect of the invention provides an apparatus to be used in a hostile environment comprising a tool head configured to receive at least one operator device, this being at least one of either a temperature detection device, a sampling device, an optical and/or thermal and/or geometric data detection device, or a restoration device; a positioning support, this being a robotic arm or cooperating with a robotic arm, able to be mechanically connected to the tool head; a processing unit configured to control the operation and movement of the apparatus, wherein the apparatus is able to execute the method for inspecting and restoring a hostile and/or dangerous environment.

The tool head is connected to the positioning support and comprises an assembly element configured to selectively couple to a mating assembly element in order to allow the selective installation of at least one operator device selected among different types of devices including a restoration device, an optical and/or thermal and/or geometric data detection device, a temperature detection operator device, a sampling device.

In another example of the invention, the robotic arm is equipped with 6 axes and 6 degrees of freedom, and it is configured to move the at least one operator device.

In another example of the invention, the tool head comprises a sensor for measuring the angular position, able to measure an angular position of the tool head.

In another example of the invention, the apparatus comprises a compressed air cooling system configured to cool the at least one operator device.

In another example of the invention, the processing unit is configured to control the apparatus to automatically install or uninstall the at least one operator device on the tool head.

In a preferential embodiment, the aperture through which to introduce the operator device and the tool head connected to it into the furnace body corresponds to the slagging door, which is disposed on the wall of the furnace.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a perspective view of an inspection and restoration apparatus, during use, according to an example of the present invention;

FIGS. 2, 2a, and 2b are schematic views of a tool head, partly of a rod to be used with the apparatus of FIG. 1, and of examples of operator devices configured to be installed on the tool head according to an example of the present invention;

FIG. 3 is a diagram of the processing unit used in the apparatus of FIG. 1, according to an example of the present invention;

FIGS. 4a and 4b show diagrams of methods performed by the apparatus of FIG. 1, according to some examples of the present invention;

FIG. 5 shows a diagram of a method performed by the apparatus of FIG. 1, according to an example of the present invention;

FIG. 6 shows a diagram of a method performed by the apparatus of FIG. 1, according to an example of the present invention.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

We will now refer in detail to the possible embodiments of the invention, of which one or more examples are shown in the attached drawings, by way of a non-limiting example. The phraseology and terminology used here is also for the purposes of providing non-limiting examples.

The embodiments described here, using the attached drawings, concern an anthropomorphic programmable inspection and/or restoration apparatus 10, hereafter simply apparatus 10, for hostile and/or dangerous environments 100, used for example to assess the need to perform maintenance interventions, the status of a production process, the presence of human beings in duress, the need to secure the environment 100 before an operator accesses it and so on, and to perform such maintenance and/or restoration interventions.

We must clarify that, in the context of the present invention, the operations indicated above can be performed in any operating sequence whatsoever, in their entirety or only in part.

The environments 100 can present conditions of extreme temperatures, such as high or cryogenic temperatures, but also high concentrations of corrosive gases, high concentration of radiation, or with a potentially explosive atmosphere, or they are simply unknown environments, difficult to access and in which dangerous conditions could exist.

Some of these environments 100 may be interiors of melting furnaces for metal processing plants, freezing apparatuses, nuclear plants, plants for the production of aggressive chemical substances and suchlike.

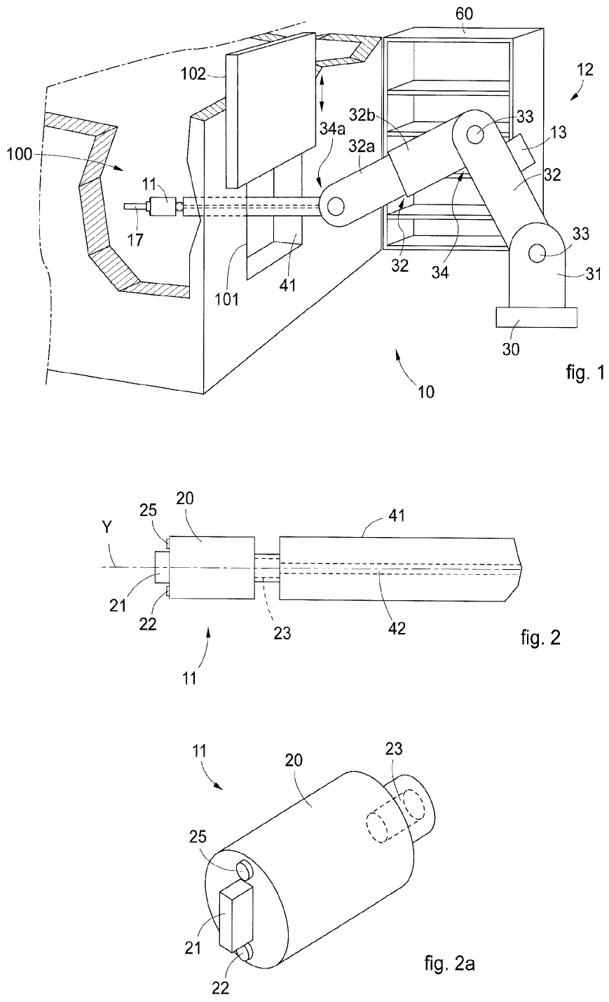

With reference to FIG. 1, the apparatus 10 comprises a tool head 11 configured to receive one or more operator devices 17, a positioning support 12, possibly a robotic arm preferably equipped with 6 axes and 6 degrees of freedom, which is configured to allow the movement of and to support the tool head 11, and a processing unit 13 configured to control the movement and operation of the tool head 11 and the positioning support 12.

The positioning support 12 is configured to support and move the tool head 11 according to linear movements, that is, forward and backward movements in one or more directions, and/or according to rotary movements around one or more points and/or around one or more axes.

The positioning support 12 is configured to make the tool head 11 advance (recede) inside (outside) the hostile environment 100, optionally through an inlet channel 101.

The inlet channel 101 is preferably a lateral inlet channel.

The advance of the tool head 11 preferably occurs along a substantially horizontal directrix.

For example, when the hostile environment 100 is a melting furnace, the positioning support 12 guides the tool head 11 into or out of the melting furnace through the inlet channel 101, which is a slagging door in which the closing element 102 has been opened, allowing the tool head 11 to enter the furnace 100. Advantageously, the positioning of the tool head 11 inside or outside the melting furnace does not require the partial or total opening of the melting furnace's vault.

The positioning support 12 comprises a rest base 30, one or more rotation members 31 attached to the rest base 30, one or more segments 32 connected to each other through articulation elements 33 to form an arm 34 connected to the rest base 30 by means of the one or more rotation members 31.

The one or more rotation members 31 are configured to rotate around an axis perpendicular to the rest base 30.

The arm 34 can be integral with the rotation member 31 or it can be connected to it by means of an articulation element 33.

An articulation element 33 is configured to connect two elements, for example two segments 32, a segment 32 and the rotation member 31, a segment 32 and the tool head 11, a segment and a rod 41 which supports the tool head 11, and suchlike. The articulation element 33 can be a hinge, a rotating element configured to allow the relative rotation of the two elements connected to it, or any element whatsoever configured for the connection of two separate parts of the apparatus 10.

The person of skill in the art will understand that the examples given above are not exhaustive, and that the articulation element 33 can be used to connect any element whatsoever, without this compromising the scope of protection of the invention.

The tool head 11 is attached to the distal end 34a of the arm 34, that is, the end of the arm 34 not connected to the rest base 30 or the rotation member 31. FIG. 1 shows the tool head 11 connected to a rod 41 which is in turn connected to the arm 34 at its distal end 34a. The person of skill in the art will understand that this configuration is not exhaustive, and that the tool head 11 can be attached directly on the segment 32 of the arm 34 at the distal end 34a of the arm 34, or it can be attached to an intermediate element between such segment 32 and the tool head 11. Such intermediate element can consist of one or more articulation elements 33, one or more rods 41, or any combination thereof which allows the mechanical connection between the tool head 11 and the positioning support 12.

The one or more segments 32 and the rod 41 can be telescopic or fixed. A telescopic segment 32 comprises reciprocally coaxial elements 32a and 32b, with slightly different diameters from each other so as to allow a first coaxial element 32a to enter into a second coaxial element 32b.

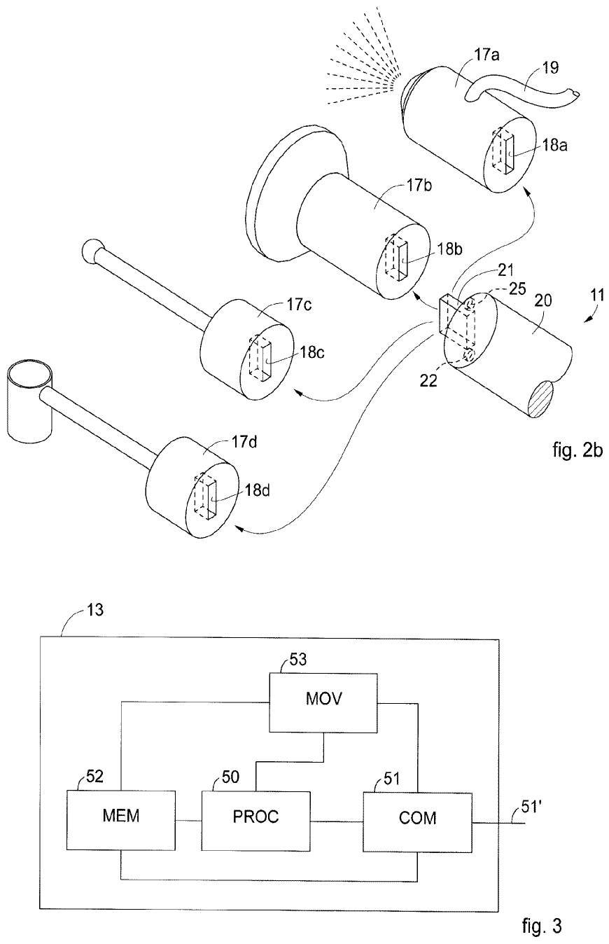

As shown in FIG. 2, the rod 41 can have an internal transmission element 42, able to cooperate with a gear 23 comprised in the tool head 11 to allow the rotation of the tool head 11 around an axis Y defined by the rod 41. The transmission element can be a drive shaft, a chain drive system, or a belt drive system or suchlike, and the axis Y can be parallel to the axis defined by the rod 41 or be perpendicular to such axis (not shown in the drawing).

In one example of the invention, the gear 23 can be configured to allow the transfer of movement to a gear (not shown) of an operator device 17 (FIG. 1) assembled on the tool head 11 independently of the tool head 11.

In an example of the invention not shown in the drawing, when the rod 41 is not present, the transmission element 42 can be inside the segment 32 corresponding to the distal end 34a of the arm 34 and connected directly to the tool head 11. In this case, the axis Y is defined by the segment 32 comprising the distal end 34a of the arm 34.

The transmission element 42 is configured to be moved by a motion control unit 53 (FIG. 3) which controls the movement of the transmission element 42 by means of one or more electronic or mechanical devices such as electric, pneumatic or hydraulic motors or actuators, or suchlike.

According to another example of the invention not shown in the drawings, the rod 41, or alternatively the segment 32 corresponding to the end 34a of the arm 34, comprises a second transmission element configured to cooperate with a second gear comprised in the tool head 11 to allow the rotation of the tool head 11 around an axis perpendicular to the axis Y. The person of skill in the art will understand that the second transmission element can be configured and disposed in a similar manner to the transmission element 42 described above.

The person of skill in the art will understand that the positioning support 12 being a robotic arm can allow the movement of the operator device 17 or of the tool head 11 which are located in the wrist of the robotic arm in any direction whatsoever of three-dimensional space. Details on the movement of the wrist of a robotic arm go beyond the scope of this disclosure and will not be considered for reasons of brevity.

In one example of the invention, the rod 41 is at least partly internally hollow to allow the passage of signal and/or power supply ducts and/or cables for connecting the tool head 11, the processing unit 13, the operator device 17 and all the elements of the positioning support 12.

Similarly, the positioning support 12 can be, at least in one part thereof, internally hollow to allow the passage of the signal and/or power supply ducts and/or cables for connecting the tool head 11, the processing unit 13, the operator device 17 and all the elements of the positioning support 12.

With reference to FIGS. 1, 2, and 2a, the tool head 11 is configured to receive one or more operator devices 17 (not shown in FIGS. 2 and 2a), including a restoration device 17a, an optical and/or thermal and/or geometric data detection device 17b, a temperature detection device 17c, a sampling device 17d for taking one or more samples of material present in the hostile environment 100, and the tool head 11 is connected to the positioning support 12 as described above.

With reference to FIGS. 2a and 2b, the tool head 11 comprises a main body 20 and at least one assembly element 21, connected to the main body 20, which allows the installation of the one or more operator devices 17. The at least one assembly element 21 is configured to allow the assembly of different types of operator devices 17 including, for example, the restoration device 17a, the optical and/or thermal and/or geometric data detection device 17b, the temperature detection device 17c, the sampling device 17d for taking one or more samples of material present in the hostile environment 100.

The assembly element 21 is also configured to couple to elements 18a, 18b, 18c, and 18d for installing, respectively, the restoration 17a, optical and/or thermal and/or geometric data detection 17b, temperature detection 17c, and sampling 17d devices. In other words, the assembly element 21 is configured to selectively couple to a mating installation element 18a, 18b, 18c, and 18d to allow the selective installation of the at least one operator device, such as the restoration 17a, optical and/or thermal and/or geometric data detection 17b, temperature detection 17c, and sampling 17d devices.

The person of skill in the art will understand that the different types of operator devices 17 shown in FIG. 2b are for illustrative purposes only and do not limit the type of operator device 17 which can be assembled on the tool head 11, or the number of operator devices 17 which can be assembled on the tool head 11.

In one example of the invention, when the hostile environment 100 is a melting furnace, the temperature detection device 17c is configured to detect the temperature of the metal bath. In the event that the hostile environment 100 is a melting furnace, the sampling device 17d is configured to take one or more samples of molten material or slag.

In an example of the invention not shown in the drawings, the main body 20 is a platform which defines an upper flat surface on which the assembly element 21 is located.

In another example of the invention, the tool head 11 comprises one or more sensors 22, such as temperature sensors, sensors for detecting chemical substances, proximity sensors, distance sensors or suchlike, or an angular position sensor 25.

According to some embodiments, the measurement of the angular position by means of the sensor 25 can allow to associate the angular position of the tool head 11 with the one or more acquired images. Advantageously, it is therefore possible to locate the acquired image with respect to the inspected environment 100 or, more generally, to move the tool head 11 or the operator device 17 on the basis of the measured angular position or on the basis of an angular position or a pattern of angular positions which are pre-determined or stored in a memory unit.

According to some embodiments, the one or more operator devices 17, 17a, 17b, 17c, and 17d and/or sensors 22 and 25 can be removably constrained to the tool head 11 by means of attachment elements, such as brackets, screws, glue and suchlike.

In another example of the invention, the tool head 11 can comprise (not shown in the drawings) one or more data communication devices, one or more data acquisition devices, such as, as a non-exhaustive example, electronic data conditioning circuits, one or several motor control and regulation systems, one or more motors, one or more power supply systems, one or more pipes and/or ducts, and suchlike, not shown in the drawing.

The person of skill in the art will understand that the previous examples are not exhaustive and that they can be combined without compromising the scope of protection of the present invention.

The tool head 11 comprises the gear 23 and is connected to the positioning support 12 in such a way that the gear 23 cooperates with the transmission element 42 of the positioning support 12 or of the rod 41 to allow the transfer of motion from the transmission element 42 to the tool head 11 or to any element, for example to the one or more operator devices 17, assembled on the tool head 11.

In one example, the gear 23 cooperates with the transmission element 42 of the positioning support 12 to allow the rotation of the body 20 of the tool head 11 around the axis Y.

In another example, the gear 23 cooperates with the transmission element 42 of the positioning support 12 to allow the rotation of the assembly element 21 of the tool head 11 around the axis Y. In this way, the one or more devices 17 are made to rotate around the axis Y independently of the main body 20 of the tool head 11, which remains integral with the rod 41 or the segment 32 corresponding to the distal end 34a of the arm 34.

The person of skill in the art will understand that the movements of the operator device 17 or of the tool head 11 are not limited to the examples given above. Moreover, the expert in the field will understand that any type of movement of a wrist of a robotic arm can be applied to the movement of the operator device 17 or of the tool head 11, without this compromising the scope of protection of the invention.

The one or more operator devices 17 can be optical and/or thermal and/or geometric data detection devices 17b able to acquire optical images, such as one or more sequences of frames or videos, also in continuous scanning; for example, they can be photo cameras, video cameras, lasers or other systems for acquiring image data and/or punctual data able to reconstruct an image and/or a geometry.

The one or more optical and/or thermal and/or geometric data detection devices 17b can be thermal imaging cameras, able to acquire thermal images or videos, or they can be ionizing electromagnetic radiation detectors (X-rays, gamma, positive or negative alpha or beta radiation), able to acquire images of the environment in the respective electromagnetic spectrum.

The one or more optical and/or thermal and/or geometric data detection devices 17b can also integrate both optical and thermal technologies within a single operator device, for example also supplying combined optical and thermal images at output.

The one or more operator devices 17 can also be cleaning devices, such as slag removal devices provided with a spatula and/or oxygen and/or other gas lances, configured for the removal of slag present, for example, in a melting furnace after metals have been melted.

The one or more operator devices 17 can also be restoration devices 17a, such as gunning devices (lances) for restoring the inert material of the melting furnace.

The one or more operator devices 17 can also be sampling devices 17d for taking one or more samples of material, for example if the environment 100 is a melting furnace, the sampling device 17d can be configured to take molten material or slag.

The tool head 11 can be configured for the installation of only one operator device 17, or several operator devices 17 simultaneously.

According to one example of the present invention, the tool head 11 contains at least one of either one or more motors or one or more electrical and/or mechanical and/or pneumatic and/or hydraulic elements for the operation and movement of the one or more devices 17 installed on the tool head 11.

With reference to FIG. 3, the movement and functionality of the apparatus 10 are controlled by the processing unit 13.

The processing unit 13 can be positioned on the arm 34, as shown in FIG. 1. Optionally, the processing unit 13 can be positioned as much as possible in proximity to the tool head 11, or inside the tool head 11, for example in order to reduce signal loss due to ambient electromagnetic noise.

According to some variants, the processing unit 13 can in any case be positioned in any suitable position in the system, even at a distance from the arm (not shown in the drawing).

The processing unit 13 can communicate any identified anomalies to the operator, for example by means of a display operator device not shown in the drawing able to display information to an operator in the form of images or text, or able to convey audio information.

According to some embodiments, the processing unit 13 can comprise an internal memory unit 52 for the storage of data, such as for example images, videos and/or image and data processing results, for example concerning possible anomalies or movement patterns of the operator device 17. In an alternative variant, the processing unit 13 can be connected to one or more external databases.

The processing unit 13 comprises a processor 50, a communication unit 51 which allows the communication of data from/to an external device, such as for example the one or more operator devices 17, the one or more sensors 22 and 25, or any electronic device whatsoever comprised in the apparatus 10 or external thereto, a memory unit 52 which allows to store data, and a movement unit 53 for controlling the movements of the apparatus 10.

The processor 50 is configured to process data and control the other units that constitute the processing unit 13. In particular, the processor 50 is configured to process the data received from the one or more operator devices 17, or from the one or more sensors 22.

In one example of the invention, the processor 50 is configured to process images acquired by the at least one operator device 17b for detecting optical and/or thermal and/or geometric data, such as photograms and/or videos. For example, it can process optical and/or thermal images and/or geometric data in order to reconstruct overlapping images with both types of information. As another example, it can reconstruct panoramic images.

The processor 50 can be able to acquire data from the sensors 22 and 25, to activate procedures for protecting the tool head 11 from hostile elements in the environment 100 and/or to process and save such data, for example for use by technologists.

As a non-exhaustive example, the protection procedures can comprise the withdrawal of the tool head 11, due, for example, to an excess in temperature indicated by a temperature sensor 22, or the repositioning of the tool head 11 in the event of a probable collision with elements such as walls, ceilings, or obstacles in general, detected for example by means of a proximity sensor 22.

According to some embodiments, the processing unit 13 can, by means of the processor 50, process data and images to identify anomalies, such as for example cracks, deposits, hot and/or cold points or suchlike.

The person of skill in the art will understand that hereafter we will refer to the processor 50 and to the processing unit 13 interchangeably.

The processing unit 13 can therefore comprise one or more processing algorithms, able for example to implement predefined decision rules or to implement programs based on artificial intelligence techniques, such as neural networks, suitably trained to detect one or more anomalies, or similar programs.

According to some embodiments, the processing unit 13 can be connected to at least one viewing operator device, not shown in the drawing, for example a pulpit or suchlike, able to allow operators to view the images and data acquired by the operator devices 17 in real time.

The image and data processing functionalities of the processing unit 13 have heretofore been described as performed by a processor 50. The person of skill in the art will understand that the processing unit 13 can contain sub-units, such as an image processing unit and a data processing unit (not shown in the drawings), which are able to perform the image and data processing functionalities, respectively, without this compromising the scope of protection of the present invention.

For data transmission, the communication unit 51 can comprise data transmission means, not shown in the drawing, for transmitting, via cable and/or wirelessly, the data sent to the processing unit 13 by the devices 17 and/or by the sensors 22 and 25. Such data transmission means can be, for example, wired systems, with or without shielded cables, wi-fi or Bluetooth communication means, or suchlike.

The communication unit 51 can comprise one or more connection devices (not shown) for managing the connection in wired systems, such as for example converters between USB, Ethernet, RS-485 and similar formats, hubs, routers or suchlike.

The processor 50 is also configured to control a movement control unit 53 for controlling the movement of the positioning support 12 and of the tool head 11 and the operation of the at least one or more operator devices 17 installed on the tool head 11.

The processing unit 13 controls the apparatus 10 to move the tool head 11 or the operator device 17 on the basis of a measurement of an angular position of the tool head 11 or of the operator device 17 obtained by means of an angular position sensor 25 or, alternatively, on the basis of a pre-set path of the operator device 17.

The apparatus 10 can also comprise an electrical control panel (not shown in the drawings) which contains elements for the power supply of the apparatus 10, connected for example to an electricity grid, and, according to an alternative, the electrical control panel can contain both the power supply elements of the apparatus 10 as well as the processing unit 13.

It will be clear to the person of skill in the art that the electrical control panel and the processing unit 13, or parts thereof, can constitute a single unit, without this compromising the scope of protection of the present invention.

The processing unit 13 is also configured to control the automatic installation and uninstallation of one or more operator devices 17 on the tool head 11, in particular, on the assembly element 21 of the tool head 11 by the apparatus 10 itself.

The one or more operator devices 17 are stored in a tool magazine 60 consisting of any space or location, or any casing, receptacle, container, rack and suchlike, defined in a position that is accessible by the apparatus 10, configured and suitable for the deposit, storage, arrangement and retrieval, by the apparatus 10 or by an operator, of the one or more operator devices 17. The person of skill in the art will understand that the tool magazine 60 can be separated from the apparatus 10 or connected to the apparatus, without this compromising the scope of protection of the present invention.

The position of the one or more operator devices 17 deposited and stored in the tool magazine 60 is known to the processing unit 13 and can be recorded in the memory unit 52 of the processing unit 13.

According to some examples of the present invention, the apparatus 10 also comprises a gas or liquid, for example air or water, protection system, not shown in the drawings. The protection system can be a system for regulating the temperature around the tool head 11, for example a heating or cooling system.

The protection system can also be a system for removing corrosive gases, for example thus preventing a high concentration of corrosive gases around the tool head 11, or suchlike.

Preferably, but not exclusively, the protection system is a compressed air cooling system.

The apparatus 10 described above is used to inspect and restore, through maintenance or other similar operations, a hostile and/or dangerous environment 100 in which the direct presence of a person is not permitted and is not possible for reasons, for example, of safety. By way of a non-limiting example, a hostile environment 100 can consist of an environment which presents conditions of extreme temperatures, either extremely high or cryogenic temperatures, an environment with a high concentration of corrosive gases or ionizing radiation, or with a potentially explosive atmosphere, or simply environments that are unknown and/or difficult to access. In one example of the invention, the hostile environment 100 is a melting furnace.

Often, or periodically, there is a need to inspect such environments, for example to assess the need for maintenance or restoration interventions, the status of a production process, the need to secure the environment before the access of an operator, and so on, and to carry out such maintenance or restoration. The apparatus 10 is used for this purpose by means of the following operations.

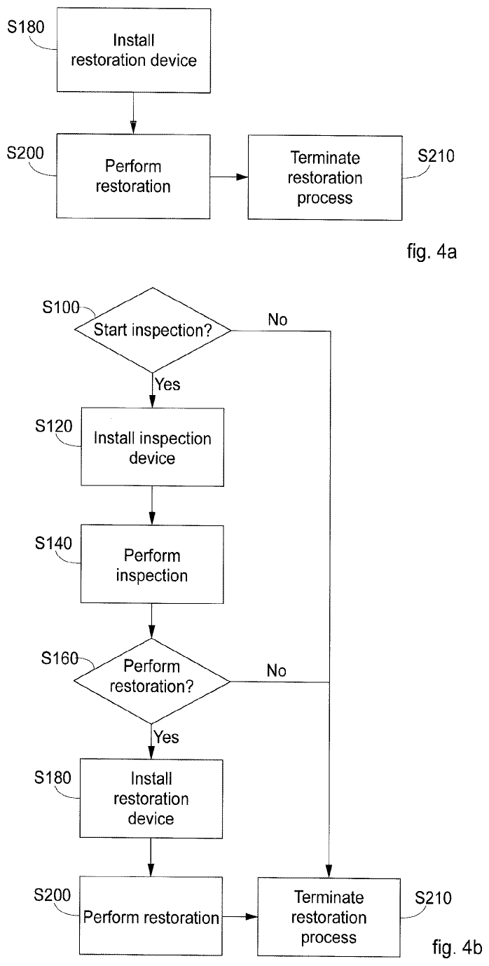

With reference to FIG. 4a, after the apparatus 10 is placed in proximity to the environment 100 to be inspected and restored, the processing unit 13 controls the apparatus to install S180 at least one restoration device 17a on the tool head 11 and to perform S200 the restoration of the environment 100 by means of the at least one restoration device 17a by positioning, by means of the positioning support 12, the tool head 11 inside the environment 100 through the inlet channel 101. Please refer to the details of the restoration mechanism described below in relation to FIG. 4b.

Optionally, with reference to FIG. 4b, before the steps of installing S180 the at least one restoration device 17a and of performing the restoration S200, the processing unit 13 determines S100 whether to start the inspection of the hostile environment 100.

In one example, the processing unit 13 determines S100 whether to start the inspection on the basis of data received from one or more sensors 22 or 25 or one or more operator devices 17 installed on the tool head 11 of the apparatus.

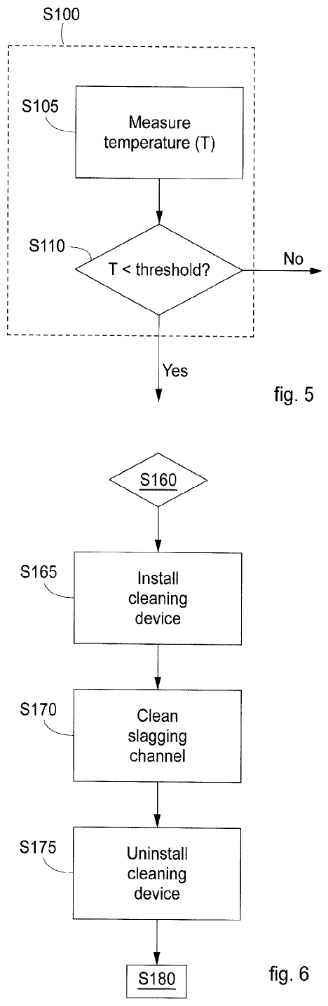

In one example, the processing unit 13 controls the apparatus 10 to install one or more temperature detection devices 17c on the tool head 11 (FIG. 2b). Subsequently, the processing unit 13 controls the one or more operator devices 17 for detecting the temperature 17c (FIG. 2b) to measure S105 (FIG. 5) the temperature of the environment 100 and to transfer the data to the processing unit 13 by means of the communication unit 51.

In one example of the invention, when the hostile environment 100 is a melting furnace, a sampling device 17d for taking one or more samples of material is installed on the tool head 11 and is configured to take one or more samples of molten material or slag.

In an example of the invention shown in FIG. 5, the one or more temperature detection devices 17 measure S105 a plurality of temperature values of the environment 100 and transfer the data to the processing unit so that it can be processed. If a plurality of temperature values is measured, the processing unit 13 processes these values obtaining for example an average value, a median value, a mode value and suchlike, and compares this value found by processing the data with the threshold temperature value.

On the basis of the comparison between the measured temperature or, equivalently, between the value obtained by processing a plurality of measured temperature values and a threshold temperature, the processing unit 13 determines to start the inspection of the environment 100.

In one example, the start of the inspection of the environment 100 is determined when the measured temperature or the value processed from a plurality of measured temperature values is lower than or equal to a threshold temperature. In another example, the start of the inspection of the environment 100 is determined when the measured temperature or the value processed from a plurality of measured temperature values is higher than or equal to a threshold temperature.

In one example of the invention, the environment 100 corresponds to the inside of a melting furnace. In this case, the data relating to the temperature inside the melting furnace are processed by the processing unit 13 to determine whether a casting of molten metal has finished. If the measured temperature or the value processed from a plurality of measured temperature values is lower than or equal to a threshold temperature, the processing unit 13 determines that the casting is finished and, therefore, to start the inspection. Optionally, the temperature detection device 17c measures the temperature upstream or downstream of the taking of one or more samples of molten material or slag, in order to determine the end of a melting sequence and to start the inspection of the environment 100.

The temperature measurement can also be performed by one or more sensors 22 already present on the tool head 11. In this case, the processing unit 13 processes the temperature data coming from the one or more sensors 22 without the need to install the one or more temperature detection operator devices 17, 17c.

If it has been determined to start the inspection, the processing unit 13 controls the apparatus 10 to install S120 (FIG. 4) at least one optical and/or thermal and/or geometric data detection device 17b on the tool head 11 for the inspection of the environment 100. In the event that at least one temperature detection device 17c has been installed on the tool head 11 to determine the start of the inspection, the processing unit 13 controls the uninstallation by the apparatus 10 of the at least one temperature detection device 17c from the tool head 11 before controlling the apparatus 10 to install S120 the at least one optical and/or thermal and/or geometric data detection device 17b on the tool head 11. Similarly, the processing unit 13 can control the uninstallation by the apparatus 10 of every other operator device 17 installed on the tool head 11, such as the sampling device 17d.

Subsequently, the processing unit 13 controls the execution S140 of the inspection of the hostile environment 100. The processing unit 13 controls the positioning support 12 to move the tool head 11 in order to position it inside the environment 100 through the inlet channel 101. The processing unit 13 controls the at least one optical and/or thermal and/or geometric data detection device 17b to acquire at least one datum relative to at least one portion of the environment 100 which can be framed by the at least one optical and/or thermal and/or geometric data detection device, optionally by means of total or partial scanning of the environment 100. The capture of at least one datum of at least one portion of the environment 100 can take place by moving the at least one operator device 17. In other words, the acquisition of data on the condition of the interior of the furnace is obtained by inserting the tool head 11 inside the environment 100, preferably, when the environment 100 is a melting furnace, downstream of the tapping. We refer to the description of the tool head 11 and of the positioning support 12 for details on the movement of the at least one operator device 17.

Once the optical and/or thermal and/or geometric data have been acquired, the processing unit 13 determines S160 whether to perform the restoration or maintenance of the environment 100 on the basis of a processing of the acquired images.

The processing of such images can comprise a recognition of the at least one image and any operation on the at least one image able to verify the presence of damage to the environment 100 and/or the need to perform a restoration of the environment 100.

It will be clear to the person of skill in the field that each operation carried out before the restoration and/or maintenance of the environment 100 allows to verify the state of the environment 100 and, therefore, to determine whether to carry out the restoration and/or maintenance. In the case of the present invention, the step of verifying the state of the environment 100 can include the step of detecting the temperature by means of the temperature detection device 17c, the step of sampling by means of the sampling device 17d, the step of detecting data by means of the optical and/or thermal and/or geometric data detection device 17b, and suchlike.

If it has been determined to perform the restoration or maintenance S160, the processing unit 13 controls the installation of at least one restoration device 17a on the tool head 11. Optionally, before the installation of the at least one restoration device 17a, the processing unit 13 controls the uninstallation of the at least one optical and/or thermal and/or geometric data detection device previously installed on the tool head 11.

In an example shown in FIG. 6, the processing unit 13 controls the apparatus 10 to perform S170 a cleaning of the inlet channel 101 to the environment 100 by means of at least one cleaning operator device 17 (not shown in the drawings). In order to perform the cleaning of the inlet channel 101, the processing unit 13 controls the apparatus 10 to install S165 the at least one cleaning operator device 17. Optionally, if one or more operator devices 17 are already assembled on the tool head 11, the processing unit 13 can control the apparatus 10 to uninstall these operator devices 17 and place them back in the tool magazine 60 before installing S160 the at least one cleaning operator device 17. The at least one cleaning operator device 17 can comprise at least one of either a spatula, a brush, a rotating brush, an oxygen or other gas lance, or any element whatsoever able to perform the removal of material by means of a physical action on the material.

Once the cleaning of the inlet channel 101 to the environment 100 has been completed, the processing unit 13 controls the apparatus 10 to uninstall S175 the at least one cleaning operator device 17.

Subsequently, the processing unit 13 controls the apparatus 10 to determine S160 whether to perform the restoration or maintenance of the hostile environment 100 by means of one or more restoration devices.

Before performing the restoration or maintenance, the processing unit 13 controls the apparatus 10 to perform, if necessary, the uninstallation of every operator device 17 already installed on the tool head 11.

Subsequently, the processing unit 13 controls the apparatus 10 to install S180 at least one restoration device 17a on the tool head 11 and, subsequently, the processing unit 13 controls the positioning support 12 to move the tool head 11 in order to position it inside the environment 100 through the inlet channel 101.

At this point, the processing unit 13 controls the apparatus 10 to perform S200 the restoration or maintenance of the inside 101 of the environment 100 by means of the at least one restoration device 17a. The processing unit 13 controls the apparatus 10 to move the tool head 11 on the basis of a measurement of an angular position of the tool head 11 obtained by means of an angular position sensor 25 or, alternatively, on the basis of a pre-set path of the operator device 17.

In one example, the restoration occurs by means of at least one restoration device 17a, this being a gunning device (gunning lance) for the deposit of restoration material, possibly refractory material, on the internal surfaces of the environment 100 by means of sprays. The at least one restoration device 17a is configured to emit one or more jets of material through one or more nozzles (not shown) so that the jets move away from the at least one restoration device 17a toward a surface of the environment to be restored.

In one example, the at least one restoration device 17a installed on the tool head 11 can be moved independently of the positioning support 12. In other words, once the positioning support 12 moves in such a way as to position the at least one restoration device 17a inside the environment 100 through the inlet channel 101, the positioning support 12 can remain in a fixed position and the tool head 11 and/or the at least one restoration device 17a can be moved in order to perform the restoration of the environment 100 as described above.

In another example, the spraying of material to perform the restoration occurs by moving both the positioning support 12 and also the restoration device 17a and/or the tool head 11.

The restoration of the environment 100 occurs by gunning with mainly vertical but generally multidirectional sprays, wherein the restoration device 17a is made to rotate around a horizontal axis so that the gunning material is deposited perpendicularly to the surface to be restored which is in front of the nozzle (not shown) of the at least one restoration device 17a.

The person of skill in the art will understand that the movement of the at least one restoration operator device 17a is a movement resulting from the combination of any movement whatsoever of the positioning support 12, of the tool head 11, and of the at least one restoration device 17a itself. This allows the at least one restoration device 17a to emit one or more jets in order to cover every area of the internal surface of the environment 100.

The gunning material reaches the nozzle of the at least one restoration device 17a by means of one or more ducts 19 which connect the at least one restoration device 17a and a container for the gunning material (not shown in the drawings). The person of skill in the art will understand that the container can be positioned in proximity to or far away from the positioning support 12, possibly protected behind a protective wall, without this changing the scope of protection of the invention.

Furthermore, the gunning material is moved by a pump or a machine for moving fluid or semi-fluid material, such as mud, slurry and suchlike, from the container to the restoration device 17a by means of the one or more ducts, so that it can be emitted by the restoration device 17a in order to be deposited in the environment 100.

The person of skill in the art will understand that what has been disclosed for the gunning material is valid if other fluid or semi-fluid materials are used for the restoration, and that this does not change the scope of protection of the invention.

Once the restoration of the environment has finished, the processing unit 13 controls the apparatus to uninstall the restoration or maintenance device 17a.

On the contrary, if in the determination step S160 it was determined to not perform the restoration, the processing unit 13 checks that the apparatus 10 terminates each operation after having, if necessary, uninstalled every operator device 17 installed on the tool head 11.

As has been disclosed, between each step of the method and the following one, the processing unit 13 controls the apparatus to automatically uninstall/install the at least one operator device 17 from/on the tool head 11. We must clarify that the installation and the uninstallation of the one or more operator devices 17 occurs outside the environment 100. Whenever the installation (uninstallation) of the one or more operator devices 17 is required, the processing unit 13 controls the positioning support 12 to move the tool head 11 in order to position it outside the environment 100 and to return (retrieve) the one or more operator devices 17 in (from) the tool magazine 60.

Moreover, the processing unit controls the apparatus 10 to perform the installation operations completely autonomously.

In the event of installation of one or more operator devices 17 on the tool head 11, the processing unit 13 controls, thanks to information contained in the memory unit 52, the apparatus 10 to move the positioning support 12 so that it approaches the tool magazine 60 and to perform the operations of recovering the one or more operator devices 17 from the position in the tool magazine 60 associated with them and of their installation on the tool head 11.

Similarly, in the event of uninstallation of the one or more operator devices 17, the processing unit 13 controls, thanks to information contained in the memory unit 52, the operations of uninstalling the one or more operator devices 17 from the tool head 11 and their deposit in the position in the tool magazine 60 associated with them.

In what follows, the method described above is referred to the particular case in which the environment 100 corresponds to the inside of a melting furnace, and in which the inlet channel 101 of the tool head 11 into the environment 100 is a slagging door in which the closing element 102 has been opened allowing the tool head 11 to enter the furnace 100.

Some actions, for example the installation or uninstallation of the at least one operator device 17, the determination of the start of the inspection, the determination of the need for restoration or maintenance, have been described in relation to the general method and will not be repeated for reasons of brevity. It will be clear to the person of skill in the art that the particular method described below corresponds to the general method described previously, and that any action whatsoever described in the general method is also valid for the particular method.

After a casting of molten metal, it may be necessary to inspect the inside of the melting furnace (the environment 100) in order to assess the need for maintenance interventions, such as restoring the refractory material which the inside of the furnace 100 is made of. In this case, the apparatus 10 is in a position, with respect to the furnace 100, such that it is possible, by moving the positioning support 12, to insert the tool head 11 inside the furnace 100 through the slagging door 101 disposed on a wall of the furnace 100.

Such wall is preferably a lateral wall of the furnace 100.

The processing unit 13 determines S100 if the casting of molten metal is finished, controlling the positioning support 12 to move the tool head 11 in order to insert it into the furnace 100 through the slagging door 101 disposed on a wall of the furnace 100, preferably a lateral wall of the furnace 100.

In one example of the invention, a sampling device 17 for taking one or more samples of material is installed on the tool head 11 and is configured to take one or more samples of molten material or slag and, optionally, the temperature detection device 17c measures the temperature upstream or downstream of this taking of one or more samples of molten material or slag, in order to determine the end of a melting sequence and to start the inspection of the environment 100.

By means of at least one temperature detection device 17c or by means of the at least one sensor 22, which are installed on the tool head 11, the processing unit 13 determines S100 if the melting sequence has ended, and therefore whether to start the inspection of the furnace 100.

It is determined that the melting sequence has ended and, therefore, that the inspection of the furnace 100 has to be started, when the temperature measured S105 by the at least one temperature detection device 17c or the one or more sensors 22 is lower than or equal to S110 a threshold temperature.

If it has been determined that the temperature is higher than the threshold temperature, the processing unit controls the apparatus 10 to terminate every operation, to move, by means of the positioning support 12, the tool head 11 out of the environment 100 and, possibly, to uninstall every operator device 17 installed on the tool head 11.

If it has been determined that the casting is finished, and therefore to start the inspection of the furnace 100, the processing unit 13 controls the execution of the inspection of the furnace 100 by using at least one optical and/or thermal and/or geometric data detection device 17b. The acquisition of optical and/or thermal and/or geometric data is obtained by inserting the tool head 11 into the environment 100 (melting furnace) preferably downstream of the tapping.

Conversely, if it has been determined to not perform the restoration or maintenance, the processing unit controls the apparatus 10 to finish every operation, to move, by means of the positioning support 12, the tool head 11 out of the environment 100 and, possibly, to uninstall every operator device 17 installed on the tool head 11.

If at least one temperature detection device 17c is installed on the tool head 11, the processing unit controls its uninstallation and the subsequent installation of the at least one optical and/or thermal and/or geometric data detection device 17b on the tool head 11.

Optionally, before the inspection step S140, the method consists in determining a level of molten material and slag, and in performing the inspection S140 and the restoration S200 downstream of the taking of one or more samples of molten material or slag.

Optionally, during the inspection step S140, the processing unit 13 controls the at least one operator device 17 to take a sample of material present inside the furnace 100, for example material coming from the walls of the furnace or residues of metal following the tapping.

On the basis of the acquired data (optical and/or thermal images and/or geometric data, and/or the sample of material), the processing unit 13 determines S160 whether to perform the restoration or maintenance of the furnace 100. We refer to the description of the general method for further details.

If it has been determined to not perform the restoration or maintenance, the processing unit controls the apparatus 10 to terminate every operation and to move, by means of the positioning support 12, the tool head 11 out of the environment 100 and, possibly, to uninstall every operator device 17 installed on the tool head 11.

If it has been determined to perform the restoration or maintenance of the environment (furnace) 100, the processing unit 13 controls the apparatus 10 to uninstall the at least one optical and/or thermal and/or geometric data detection device 17b still installed, and to install S180 at least one restoration device 17a, such as gunning devices (lances), on the tool head 11.

At this point, the processing unit 13 controls the apparatus 10 to perform the restoration or maintenance S200 of the hostile environment 100 by means of the at least one restoration device 17a as described in relation to the general method.

We also refer to the general method for details on the possible execution of the cleaning of the slagging door shown in FIG. 6.

In the following claims, the sole purpose of the references in brackets is to facilitate reading and they must not be considered as restrictive factors with regard to the field of protection claimed in the specific claims.

1. Method for inspecting and/or restoring a hostile and/or dangerous environment, performed by an apparatus which comprises a tool head, said tool head being mechanically connected to a positioning support which is a robotic arm and being configured to receive at least one operator device, said apparatus being selected from at least one of either a restoration device, an optical and/or thermal and/or geometric data detection device, a temperature detection device, or a sampling device for taking one or more samples of material, wherein the method comprises:
installing at least one of either said at least one restoration device, said optical and/or thermal and/or geometric data detection device, said temperature detection device, or said sampling device;
performing the restoration by means of said at least one restoration device, or verifying the state of said environment by means of said optical and/or thermal and/or geometric data detection device or said temperature detection device or said sampling device, by positioning, by means of said positioning support, said tool head inside said environment through a lateral inlet channel.

2. Inspection and/or restoration method as in claim 1, wherein the method, prior to the steps of installing said at least one restoration device and of performing the restoration, comprises:
determining whether to start the inspection of said environment by means of said at least one temperature detection device;
if the inspection is started, installing said at least one optical and/or thermal and/or geometric data detection device on the tool head, and performing the inspection by positioning, by means of the positioning support, the tool head inside said environment through an inlet channel and acquiring optical and/or thermal and/or geometric data, by means of said at least one optical and/or thermal and/or geometric data detection device, of at least one framed zone of said environment;
uninstalling said at least one optical and/or thermal and/or geometric data detection device by positioning, by means of said positioning support, said tool head outside said environment through said inlet channel;
determining whether to perform the restoration of the environment on the basis of a processing of the images acquired, by means of a processing unit comprised in the apparatus.

3. Inspection and/or restoration method as in claim 2, wherein determining whether to start the inspection comprises:
installing on said tool head at least one said temperature detection device in order to measure the temperature of said environment by positioning, by means of the positioning support, the tool head inside said environment through said inlet channel;
determining, by means of the processing unit, to start the inspection if the measured temperature is lower than a threshold temperature and uninstalling said at least one temperature detection device by positioning, by means of the positioning support, the tool head outside said environment through said inlet channel.

4. Inspection and/or restoration method as in claim 3, wherein, when the environment is a melting furnace, said inlet channel corresponds to a slagging door disposed on the wall of said melting furnace, and determining whether to start the inspection comprises:
performing a sampling of one or more samples of molten material or slag by means of a sampling operator device;
measuring the temperature upstream or downstream of said sampling, in order to determine the end of a melting sequence and to start the inspection of said environment.

5. Inspection and/or restoration method as in claim 1, wherein the acquisition of optical and/or thermal and/or geometric data is obtained by inserting the tool head inside the environment, preferably, when the environment is a melting furnace, downstream of the tapping.

6. Inspection and/or restoration method as in claim 1, wherein said processing of the acquired images comprises evaluating whether the restoration is necessary on the basis of a recognition of said acquired images.

7. Inspection and/or restoration method as in claim 1, wherein said method comprises, prior to performing the restoration of the environment:
installing at least one said cleaning operator device comprising a spatula on the tool head, and cleaning said inlet channel;
uninstalling said at least one cleaning device.

8. Inspection and/or restoration method as in claim 1, wherein performing the restoration of said environment comprises performing the restoration by means of said at least one restoration device, this being a gunning lance which executes vertical sprays of refractory material toward the inside of said environment.

9. Inspection and/or restoration method as in claim 1, wherein the method comprises cooling at least one of said at least one operator device by means of a flow of gas or liquid.

10. Inspection and/or restoration method as in claim 1, wherein the method comprises moving said tool head on the basis of a measurement of an angular position of said tool head obtained by means of a sensor or, alternatively, on the basis of a pre-set path of the operator device.

11. Inspection and/or restoration method as in claim 1, wherein, when the environment is a melting furnace, the method comprises:
determining a level of molten material and slag;
performing the inspection and the restoration downstream of the sampling of one or more samples of molten material or slag.

12. Apparatus to be used in a hostile environment which comprises:
a tool head,
a positioning support, this being a robotic arm able to be mechanically connected to said tool head,
a processing unit configured to control the operation and movement of said apparatus,
wherein said tool head is connected to the positioning support and comprises a assembly element configured to selectively couple to a mating assembly element in order to allow the selective installation of at least one operator device selected from one or more of either a restoration device, an optical and/or thermal and/or geometric data detection device, a temperature detection device, and in that said apparatus is able to execute the method in accordance with claim hereinbefore.

13. Apparatus as in claim 12, wherein said robotic arm is equipped with 6 axes and 6 degrees of freedom and is configured to move said at least one operator device installed on said tool head.

14. Apparatus as in claim 12, wherein said tool head comprises a sensor for measuring the angular position, able to measure an angular position of said tool head.

15. Apparatus as in claim 12, wherein said tool head is assembled on a rod connected to one end of the positioning support.

16. Programmable anthropomorphic operating apparatus as in claim 12, wherein said apparatus comprises a compressed air cooling system configured to cool said at least one operator device.

17. Apparatus as in claim 12, wherein said processing unit is configured to control the apparatus in order to automatically install or uninstall said at least one operator device on said tool head.
